(19) United States
(12) Patent Application Publication
(10) Pub. No.: US 2015/0295435 A1
(43) Pub. Date: Oct. 15, 2015

(54) Retractable Electronic Device Battery Charger Keychain

(71) Applicant: Ian Lennon Reeves, Eagan, MN (US)

(72) Inventor: Ian Lennon Reeves, Eagan, MN (US)

(21) Appl. No.: 14/251,600

(22) Filed: Apr. 12, 2014

(51) Int. Cl. H02J 7/00

(52) U.S. Cl. CPC H02J 7/0042

(57) ABSTRACT

The invention provides users the ability to attach a battery charger intended to recharge the battery of an electronic device to a key ring, key set, or any of the like. The shell of the electronic device battery charging device includes an extruding hole which allows for an attaching device such as key ring, clip, or fastener to be connected to its body. The cord in which transfers the electricity from the power source into the device, has the capabilities to be refracted into the shell of the battery charging device which allows for storing and/or travel of the invention, without the inventions' cord to remain uncoiled.

### BACKGROUND OF THE DISCLOSURE

The idea for this invention came about from the need to solve an issue. The dilemma that myself and others I encountered was that with the amount of money we spend on electronic devices, both the device itself and the monthly service it is rather disappointing and useless to us when the battery life has run its course while we were out and about or handling day to day tasks. While things such as car chargers do exist, it hardly solves the problem long term, being that most often one does not spend a significant amount of time in their automobile, especially not the required amount of time to give your electronic device's battery ample power.

My second issue that I not only faced, but also witnessed others in the same situation countless times was arriving to a friends residence and asking what type of charger they have or if they have one to accommodate my electronic device. After this short and frequent dialogue the host or hostess would proceed to search every inch of their home looking to assist in the issue because more than likely they had been in the exact scenario at one point or another.

A possible solution to this problem that one would more than likely suggest is to simply bring their charger with them wherever they go. This was hardly the answer to my problem as I found myself constantly leaving said battery charger wherever it was that I decided to carry it with me to. This led to the constant purchasing of new chargers, not to mention the inconvenience of returning home without a charger, and the hassle of having to visit a retailer during a lunch break after going through the entire morning and previous evening without access to my device as it sat in my hands powerless. In addition to leaving the battery charger in various places, having to carry the bulky device with its cord continuously unraveling was a hassle and unattractive option being a male and not having the luxury of carrying a purse with me.

After finally deciding I have had enough, I began to brainstorm a possible solution that I could create on my own to help solve this problem that I know people all over the world faced regularly. While electronic device battery chargers obviously exist, I implemented specific features in order to change the functionality and allow for convenient travel whenever one goes. In addition to its cord being retractable making for easier and cleaner travel, its attachable key chain like design adds to the simplicity of the devices' mobility while also making it nearly impossible to leave behind as it allows users the option of attaching the electronic device battery charger to their set of keys. This feature will ensure that your charger returns with you every time you leave.

### DETAILED DESCRIPTION OF THE DISCLOSURE

The Retractable Electronic Device Battery Charger Key Chain is a battery charging mechanism with its design granting its user the ability to attach said device to a key chain, key ring, or any of the like. Its retractable cord, which allows competency for the cord to be coiled back into the apparatus' casing, grants users capability to travel from location to location without the issue of having a cord and/or wire wrapped around the outside of the devices' body.

One of the two main components in terms of design for this invention is the key chain aspect. This characteristic serves an ideal purpose of granting the user the functionality of an electronic device battery charger for their electronic device which is carried on a regular and consistent basis attached to their key ring, key chain, or the like each and every time one were to leave their current location with their set of keys. Placed on the body of the Retractable Electronic Device Battery Charger Key Chain is a structure that allows for a key chain, key ring, or attachment piece to be connected to the devices' body, more specifically outside shell casing. With the attachment piece in place users will be able to attach the intended connecting portion of the attachment piece onto their set of keys, key chain, or any of the like. The second objective of this aspect of the inventions' design is to prevent misplacement and the common event of leaving behind an electronic devices' battery charger at a location it was temporarily brought to. With the inventions' design allowing users to connect their keys, key chain, key ring, or the like to the device it makes for remembrance of the device a significantly more realistic possibility. The second feature in regards to the design of the Retractable Electronic Device Battery Charger Key Chain is the inventions retracting cord. The devices' cord has the ability to be drawn back in to the body of the device where it will be both coiled and stored. The inventions' retractable feature will function in two (2) possible ways. The first, when the cord is extended to its maximum length, the user will experience a pull in the opposite direction from which they are extending the cord. This signals the cord has reached its end and upon release will begin retracting back into the devices' body. Second, with the use of a button located on the outside of the devices' body/casing the cord will retract into the devices' body/casing. At the users discretion the cord can be pulled causing the cord to be extracted and unraveled from the devices' body in which time the device will be ready for use. The intended purpose of this feature is to grant users the ability to travel from one location to the next without having the cord, which transmits electric charge from the power source into the device hanging free or wrapped around the outside of the chargers' body or casing. This will allow for simpler and neater transportation of the Retractable Electronic Device Battery Charger. The cord is stored inside of the devices' body on a set of rotatable wheels with the capacity to hold the cord in its entirety.

### CONCLUSION AND SCOPE OF THE DISCLOSURE

### Conclusion

The Retractable Electronic Device Battery Charger Key Chain offers its user the convenience of having a battery charger for their electronic device in a neat and easy to carry fashion. Given the fact that often times when one leaves their home, they are leaving with their keys as well, having a battery charger for a device that is frequently in use and in many ways a necessity is one advantage that this invention renders. In addition to the inventions keychain design, it allows for the necessary cord, which plugs into the phone in order to deliver electricity from the power source to the phone to be retracted in to the body of the invention. This retracting capability of the device takes place through one of two ways. The first being a button, that upon being pushed will cause the cord to be retracted into the inventions' body. The second method of retracting is through the use of hyperextending the cord. When the cord is pulled beyond its intended length it will methodically retract and recoil back into the body of the device.

### Scope

The title of this invention is the Retractable Electronic Device Battery Charger Key Chain, which has two (2) main components: a retractable cord for the cord that transmits electricity from a power source into the electronic device. The second main function being an attachment device that allows for connecting the invention to a key chain, key ring, or the like. While the inventions title includes the term key chain, the legal scope should not be limited to the form(s) discussed prior. Actual method of use will be determined by individual users, some electing to attach the invention to other objects besides keys, key chains, key rings, or the like. Possible objects in which users could opt to attach their retractable electronic device battery charger key chain to include, but should not be limited to: bags, backpacks, purses, loops made for belts on trousers, skirts, or the like. The prior are examples of potential articles which maintain the ability and have been shown to provide a reasonable space for users to attach a key chains, key rings or another attachment type devices. The part of the title that reads key chain is designed solely as a name for the invention and should not limit the legal scope in terms of the devices' attaching capabilities.

### DRAWING DESCRIPTION FOR THE DISCLOSURE

This documents' intent is to describe each of the claims made in the drawings of this disclosure.

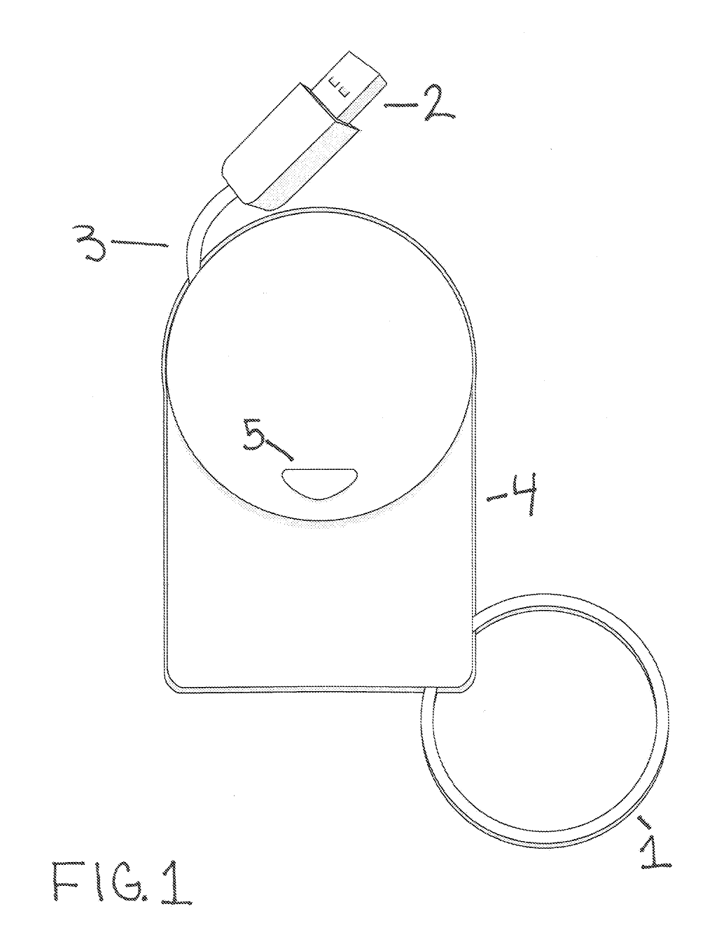

FIG. 1—Front view of the disclosure (Retractable Electronic Device Battery Charger Key Chain). This figure displays the invention from the perspective of an individual viewing the inventions' intended front.
1. Key Ring. This aspect allows for the invention to be attached to another ring intended to posses a key(s) or to attach a key to the intention.
2. DC Power Input Piece. This facet of the invention is to be inserted into the electronic device to allow for battery charging. (Actual piece varies depending on the type of device that is being charged.)
3. Retractable cord. The cord is shown in a semi-retracted position, with the majority of the cords stored around a wheel located on the interior of the inventions' body.
4. Body/Casing. This is the body of the device, which contains electronic wiring, as well rotatable wheel for retractable cord.
5. Button. This feature is a button with the capability to be pressed in order to begin the retraction process when the cord is uncoiled and not refracted.

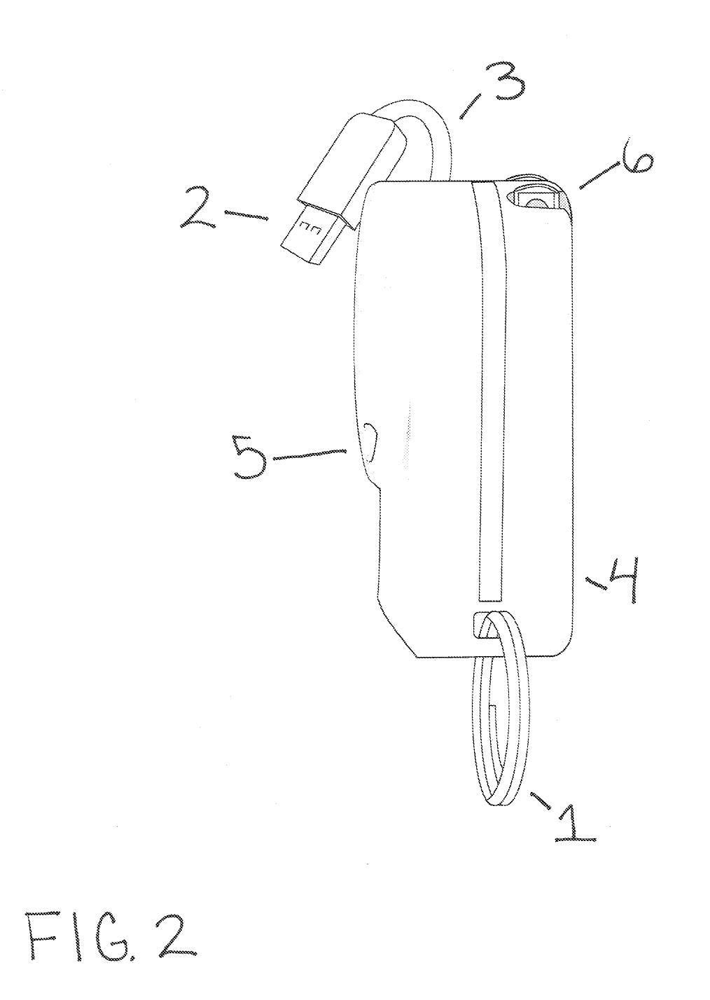

FIG. 2—Side view of the disclosure (Retractable Electronic Device Battery Charger Key Chain). This figure displays the invention from the perspective of an individual viewing the invention from its right side. The right side is a mirror image of the inventions' left side, making the right side view identical to the left side view.
1. Key Ring. This aspect allows for the invention to be attached to another ring intended to posses a key(s) or to attach a key to the intention.
2. D/C Power Input Piece. This facet of the invention is to be inserted into the electronic device to allow for battery charging. (Actual piece varies depending on the type of device that is being charged.)
3. Retractable cord. The cord is shown in a semi-retracted position, with the majority of the cord stored around the wheel located on the inside of the inventions' body.
4. Body/Casing. This is the body of the device, which contains electronic wiring, as well rotatable wheel for retractable cord.
5. Button. This feature is a button with the capability to be pressed in order to begin the retraction process when the cord is uncoiled and not retracted
6. Electric Prongs. This view displays the devices' electric prongs in their upright, and folded inward position.

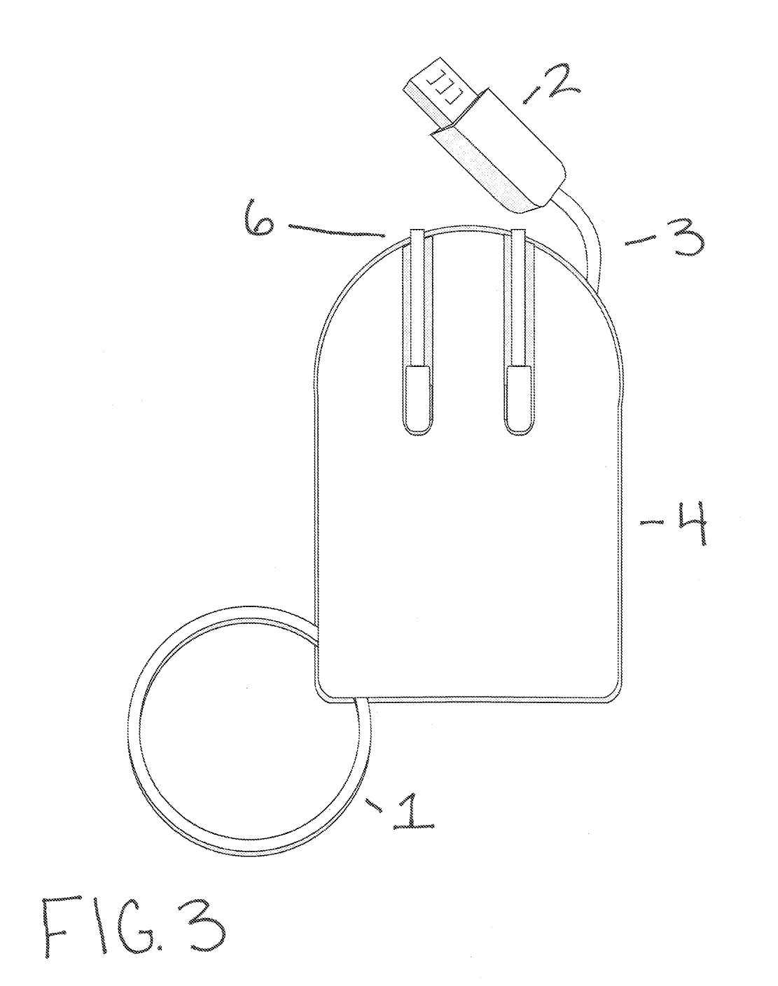

FIG. 3—Back view of the disclosure (Retractable Electronic Device Battery Charger Key Chain). This figure displays the invention from the perspective of an individual viewing the inventions' intended back.
1. Key Ring. This aspect allows for the invention to be attached to another ring intended to posses a key(s) or to attach a key to the intention.
2. D/C Power Input Piece. This facet of the invention is to be inserted into the electronic device to allow for battery charging. (Actual piece varies depending on the type of device that is being charged.)
3. Retractable cord. The cord is shown in it a semi-retracted position, with the majority of the cord stored around the wheel inside of the inventions body.
4. Body/Casing. This is the body of the device, which contains electronic wiring, as well rotatable wheel for retractable cord.
6. Electric Prongs. This view displays the devices' electric prongs in their upright, and folded inward position.

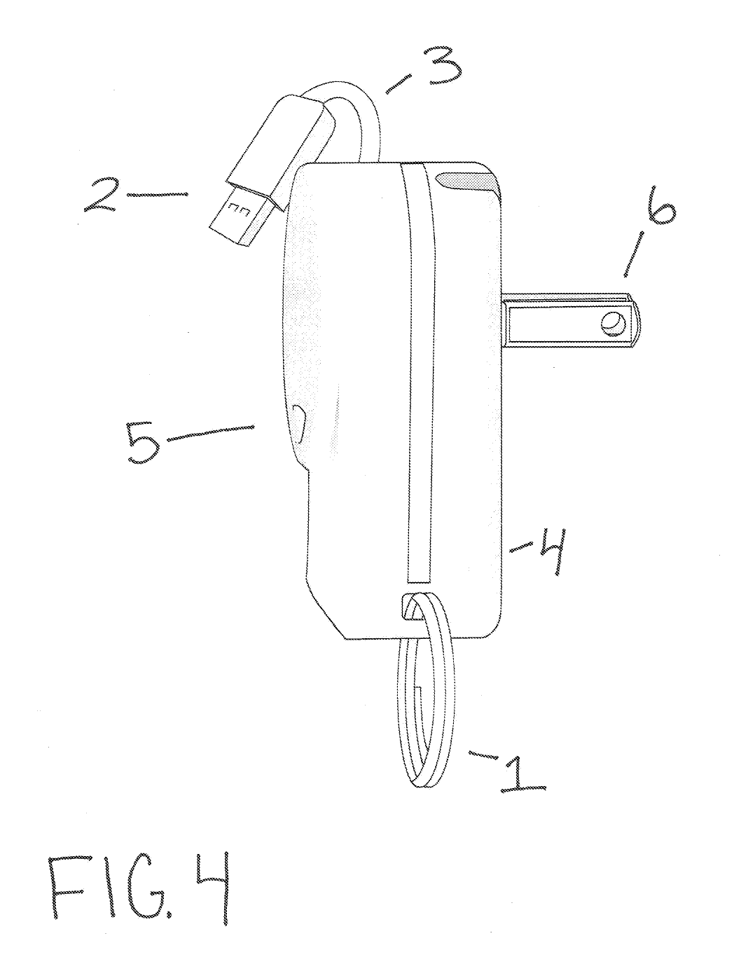

FIG. 4—Side view of the disclosure (Retractable Electronic Device Battery Charger Key Chain). This figure displays the invention from the perspective of an individual viewing the invention from its right side. The right side is a mirror image of the inventions' left side, making the right side view identical to the left side view.
1. Key Ring. This aspect allows for the invention to be attached to another ring intended to posses a key(s) or to attach a key to the intention.
2. D/C Power Input Piece. This facet of the invention is to be inserted into the electronic device to allow for battery charging. (Actual piece varies depending on the type of device that is being charged.)
3. Retractable cord. The cord is shown in a semi-retracted position, with the majority of the cords stored around the wheel located on the interior of the inventions' body.
4. Body/Casing. This is the body of the device, which contains electronic wiring, as well rotatable wheel for retractable cord.
5. Button. This feature is a button with the capability to be pressed in order to begin the retraction process when the cord is uncoiled and not retracted
6. Electric Prongs. This view displays the devices' electric prongs in their functioning state. Folded down and outward, in an extruding position.

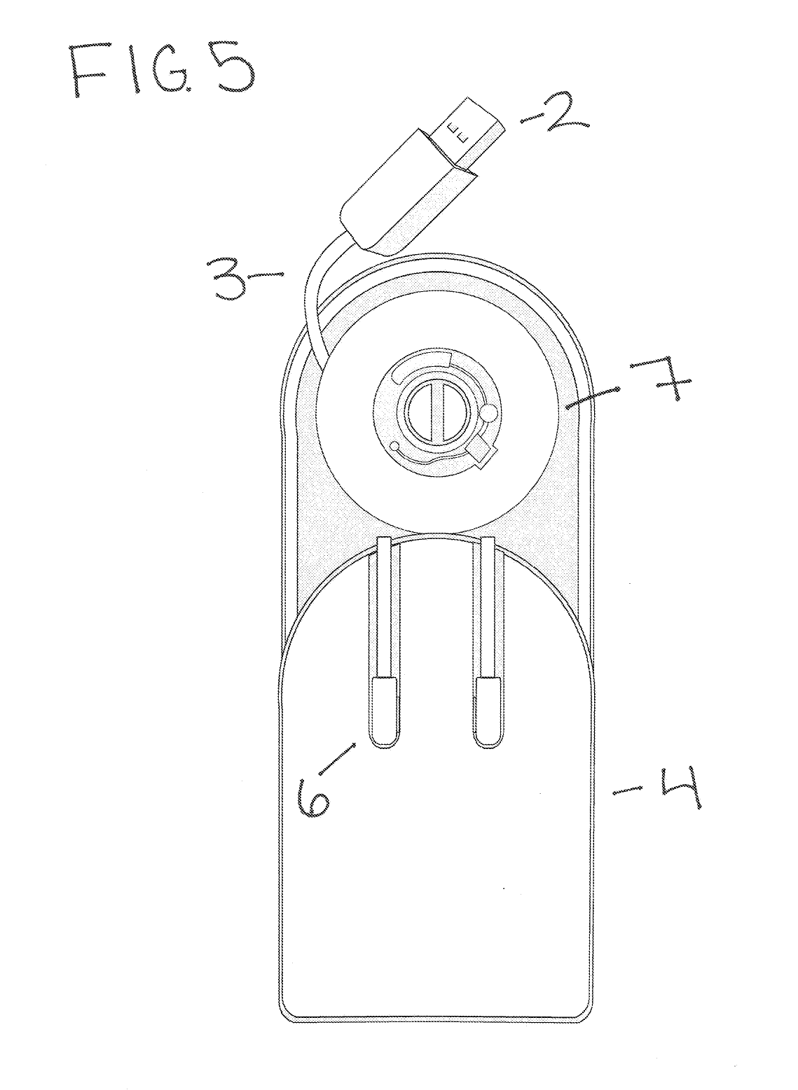

FIG. 5—Back/Interior view of the disclosure (Retractable Electronic Device Battery Charger Key Chain). This figure displays the invention from the perspective of an individual viewing the invention from its intended back. The intended purpose of this view is to diagram the rotatable wheel on the devices' interior, used for storing the retractable cord.
2. D/C Power Input Piece. This facet of the invention is to be inserted into the electronic device to allow for battery charging. (Actual piece varies depending on the type of device that is being charged.)
3. Retractable cord. The cord is shown in a semi-retracted position, with the majority of the cords stored around the wheel located on the interior of the inventions' body.
4. Body/Casing. This is the body of the device, which contains electronic wiring, as well rotatable wheel for retractable cord.
6. Electric Prongs. This view displays the devices' electric prongs in their upright, and folded inward position.
7. Rotatable Wheel. Image displays the wheel like device which stores the retractable cord in a neat fashion, when the retractable cord is inside of the devices' body.

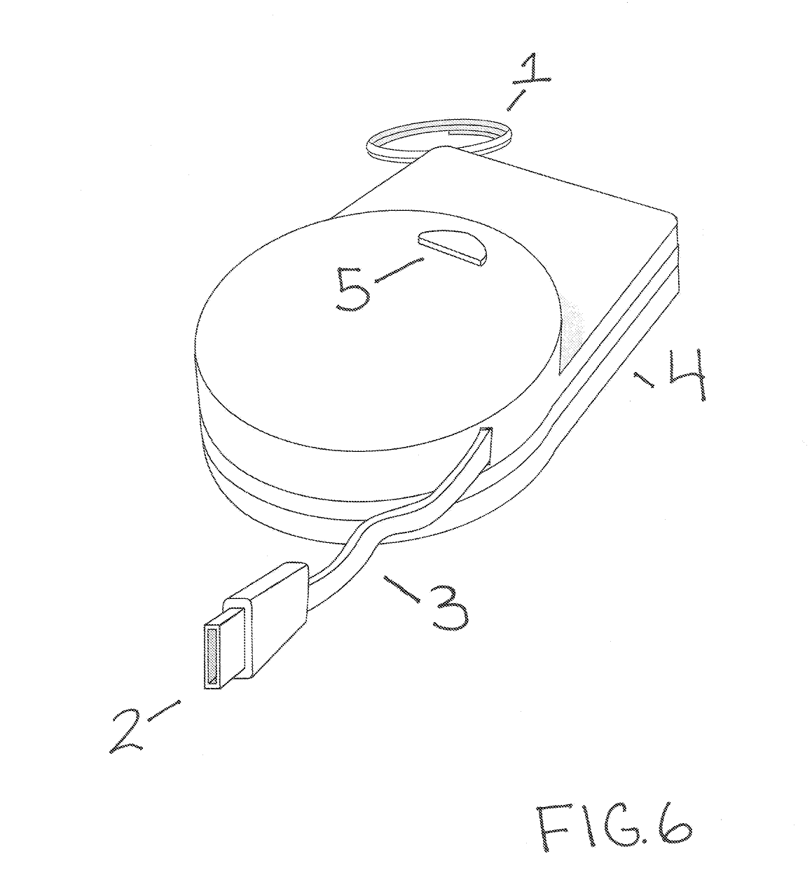

FIG. 6—Top view of the disclosure (Retractable Electronic Device Battery Charger Key Chain). This figure displays the invention from the perspective of an individual viewing the inventions' intended top.
1. Key Ring. This aspect allows for the invention to be attached to another ring intended to posses a key(s) or to attach a key to the intention.
2. DC Power Input Piece. This facet of the invention is to be inserted into the electronic device to allow for battery charging. (Actual piece varies depending on the type of device that is being charged.)
3. Retractable cord. The cord is shown in a semi-retracted position, with the majority of the cord stored around a wheel located on the interior of the inventions' body.
4. Body/Casing. This is the body of the device, which contains electronic wiring, as well rotatable wheel for retractable cord.
5. Button. This feature is a button with the capability to be pressed in order to begin the retraction process when the cord is uncoiled and not retracted.

The embodiments of the invention in which an exclusive property or privilege is claimed are defined as follows:

1. An electronic device battery charger comprising: Excess space inside of the interior body; rotatable wheel with capacity to possess the cord of the battery charger in its entirety allowing for cord to be retracted into the inventions' body; key ring connected onto the exterior body of electronic device battery charger allowing for attachment to objects with capabilities to posses attachments.
